(19) United States
(12) Patent Application Publication
(10) Pub. No.: US 2004/0021785 A1
(43) Pub. Date: Feb. 5, 2004

(54) Dome housed video camera assembly with 180 degree tilt motion

(76) Inventors: Yacov Pshtissky, Bayside, NY (US); Rein S Randmae, Ft. Solonga, NY (US)

Correspondence Address: Michael J Sweedler, Darby & Darby, Post Office Box 5257, New York, NY, 10150-5257, US

(21) Appl. No.: 10/312,457

(22) PCT Filed: Jun. 22, 2001
(86) PCT No.: PCT/US01/19847

(30) Foreign Application Priority Data
Jun. 22, 2000 (US) 60213342

(51) Int. Cl. H04N 5/335

(52) U.S. Cl. 348/275

(57) ABSTRACT

A closed circuit television surveillance system of the type used with a dome housing includes a camera which can be scanned with respect to pan and tilt axes. The camera is capable of scanning almost 180° about the tilt axis. As the camera passes the vertical position, the image scan of the camera is flipped electronically so that the image on the monitor appears right-side up even though the camera position has changed to up-side down after it passes the vertical position.

### FIELD OF THE INVENTION

The present invention relates generally to video camera assemblies for use in surveillance systems and, more particularly, to dome housed video camera assemblies with the ability to tilt 180 degrees.

### BACKGROUND OF THE INVENTION

Video surveillance cameras are sometimes placed in transparent hemispherical domed housings for the purpose of surveying an area of 360 degrees horizontally and about 180 degrees vertically. The vertical viewing area usually extends from a horizontal position of the camera in one direction, downward to a vertical position and continuing upward to a horizontal position in the opposite direction.

Cameras in domed housings have traditionally been mounted in motorized gimbal systems allowing a 360 degree horizontal “pan” motion and a 90 degree vertical “tilt” motion. Cameras have not been allowed to rotate beyond the 90 degree position because, if they do, the camera is positioned upside down, producing an upside down image on the monitor. In order to cover the remaining 90 degrees of vertical viewing area, the camera must first pan 180 degrees and then tilt upward 90 degrees. In this way, the image reversal problem has been avoided since the camera is never in an inverted position.

In a conventional domed housing, whenever a target which must be followed moves in such a way that it requires the camera to tilt beyond the 90 degree position, the camera must first pan 180 degrees in order to follow the target. This may be illustrated by an example where a ceiling mounted camera is following a person walking directly below it in a straight line. First, to keep the person in sight, the camera must gradually tilt down to the vertical 90 degree position, then spin around 180 degrees and tilt up again to follow the person. The 180 degree horizontal turnaround takes some time which may result in the loss of the target. Furthermore, it requires the mechanism to work harder in order to execute the motion which may result in premature wear and failure of the equipment.

It is an object of this invention to expand the vertical tilt travel of a video camera housed in a domed housing from 90 degrees to 180 degrees while preserving an upright orientation of the image on a monitor.

It is a further object of this invention to eliminate the time lag associated with a 180 degree horizontal pan travel necessary to execute a reversal of the video image when the camera tilt motion exceeds 90 degrees.

It is another object of this invention to eliminate the possibility of losing a moving object from sight during a video surveillance event which exists when executing a 180 degree horizontal pan travel to reverse the video image when the camera tilt motion exceeds 90 degrees.

It is still another object of this invention to reduce the wear and tear on the horizontal pan mechanism associated with a 180 degree horizontal pan travel necessary to execute a reversal of the video image when the camera tilt motion exceeds 90 degrees.

### SUMMARY OF THE INVENTION

This invention overcomes the above mentioned disadvantages by allowing the camera to traverse the full 180 degrees of tilt motion. The image reversal that is necessary at the 90 degree point of travel is accomplished by reversing the video image sweep in the camera. It is only necessary that reversal occur at the proper tilt angle. This reversal of image will occur instantaneously thus eliminating the time lag and mechanical wear associated with the 180 degree horizontal pan travel.

Further objects and advantages of the invention will become apparent from the following description and the drawings.

### BRIEF DESCRIPTION OF THE DRAWINGS

FIGS. 1A through 1D are sequential schematic views showing the camera tilt motion through a 180 degree angle in a conventional video surveillance dome.

FIGS. 2A through 2D are sequential schematic views showing the camera tilt motion through a 180 degree angle for the present invention.

FIG. 3 is a schematic block diagram of a control circuit for use with the invention;

FIG. 4 is a perspective view showing the details of a camera positioning mechanism according to a preferred embodiment of the invention;

FIG. 5 is a perspective view from a different vantage point showing a preferred embodiment of the invention;

FIG. 6 is a plan view of a pan encoder wheel according to the preferred embodiment; and

FIG. 7 is a plan view of the tilt encoder wheel according to the preferred embodiment.

### DESCRIPTION OF A PREFERRED EMBODIMENT

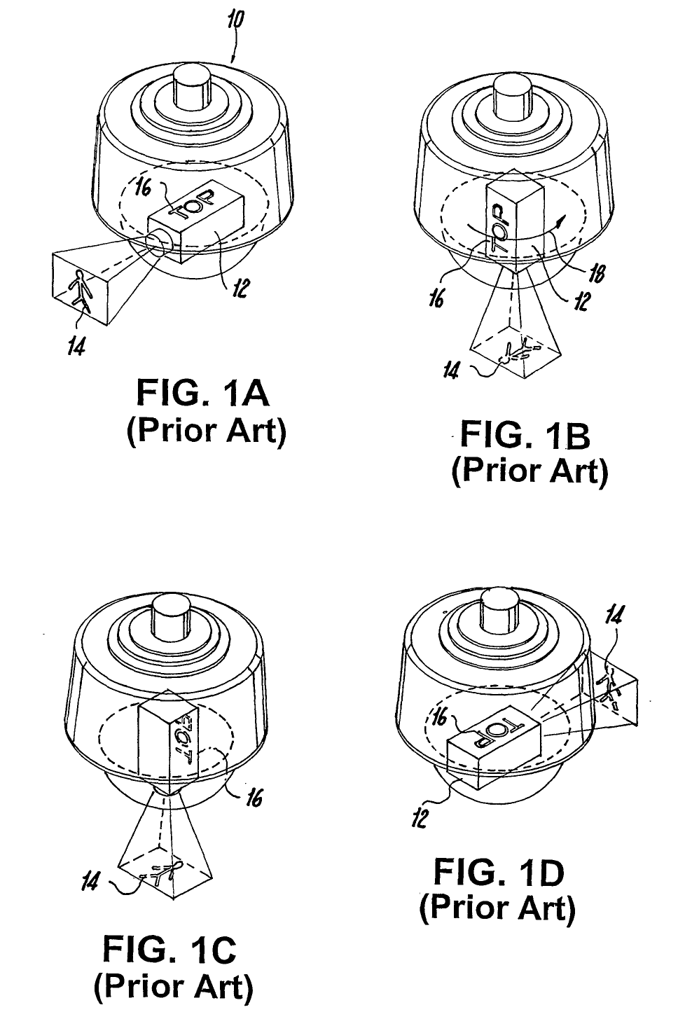

FIG. 1 shows a conventional arrangement of a video surveillance camera 12 pivotally mounted in a domed housing 10. The camera 12 is fitted with a motorized mechanism (not shown) allowing it to rotate both is azimuth (pan) and in elevation (tilt). The orientation of camera 12 may be observed by referring to the word “TOP” 16 inscribed, for the purpose of illustration, at the top surface of the camera, whereas the orientation of the image on the video monitor may be seen from the hypothetical projection of the image 14 at the front of the camera 12.

FIG. 1A shows camera 12 oriented in a horizontal position looking to the left. The image 14 is oriented in an upright position. FIG. 1B shows camera 12 having tilted 90 degrees to a vertical position. Since the tilt travel is restricted to 90 degrees, in order to enable the camera to continue beyond 90 degrees, it must first execute a 180 degree pan motion. This is shown by an arrow 18. FIG. 1C shows the position of the camera 12 after executing the pan motion. Note that the image 14 has now rotated 180 degrees but its relationship to the “TOP” indication 16 on the camera has not changed. FIG. 1D shows the position of camera 12 after traversing 90 degrees in the opposite direction. It can be seen that image 14 is again upright and unchanged with respect to camera 12.

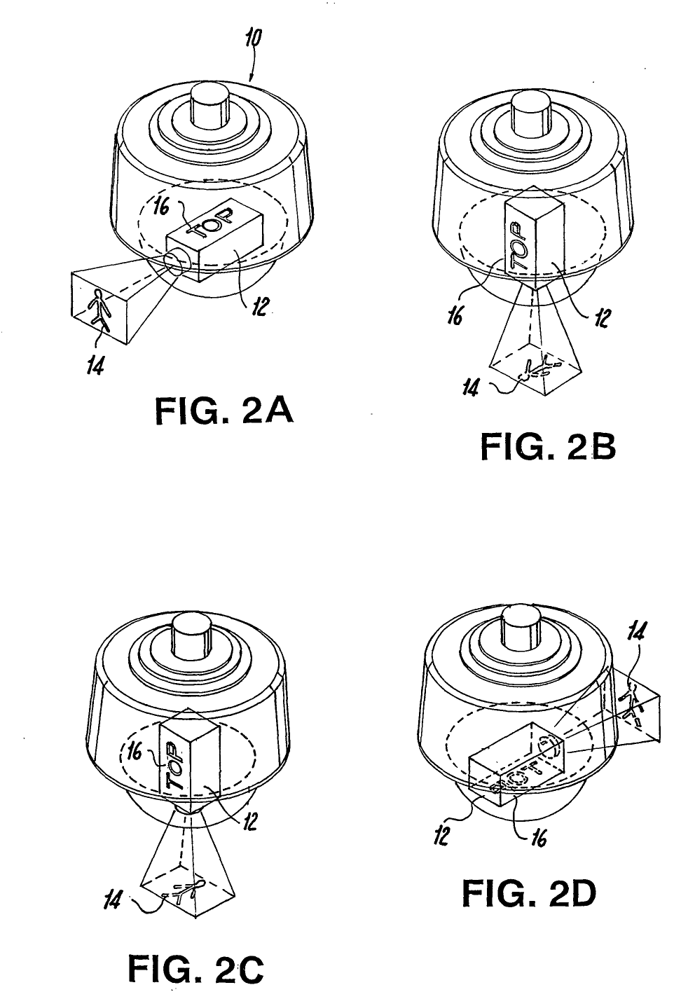

FIG. 2 shows a similar sequence for the present invention. FIGS. 2A and 2B are identical to FIGS. 1A and 1B showing the first 90 degrees of tilt motion. FIG. 2C however differs in that camera 12 has not rotated 180 degrees in pan; instead, the image reversal has occurred at the 90 degree point of travel in the camera by electronic means. FIG. 2D shows that when camera 12 is now rotated the remaining 90 degrees, its final position is inverted but image 14 remains upright.

It is apparent from the above discussion that the present invention allows the camera to rotate a full 180 degrees in tilt without having to execute a 180 degree pan rotation midway in its travel which is necessary in a conventional video camera installation.

Thus, the invention provides several advantages over a conventional video camera installation in a surveillance dome. By allowing the camera to rotate a full 180 degrees in tilt, the 180 degree pan rotation at the 90 degree tilt angle is eliminated. The pan rotation is replaced by an electronic image reversal in the camera. This method eliminates: (1) additional wear in the pan drive mechanism, (2) the time lag necessary to make the 180 degree reversal, (3) a possibility of losing track of the target during the 180 degree pan reversal, and (4) additional complexity in the logic of driving the camera.

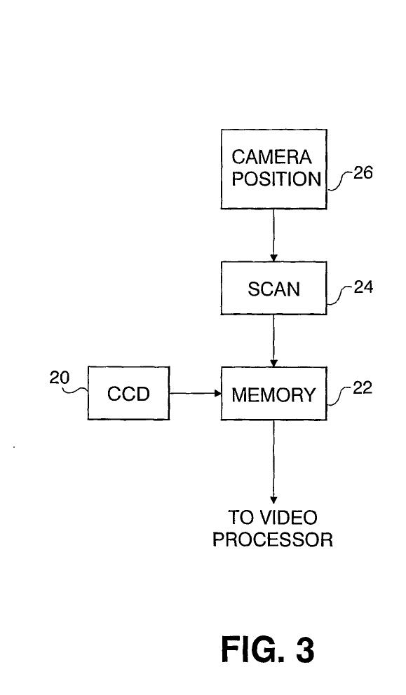

FIG. 3 is a block diagram of a system which can be used to reverse a video image as the camera tilts past a vertical position. The camera includes a conventional charge coupled device (CCD) which senses the image and transfers the video information to a memory 22. In conventional video cameras, the information stored in memory is scanned by a scanning circuit 24 and then processed to produce a video signal which can be displayed in the usual manner. In accordance with the invention, a sensing device 26 monitors the tilt position of the camera and produces an output when the camera rotates past 90 degrees. As described above, this means that the image must be reversed (previously accomplished by panning the camera 180 degrees). In accordance with the invention, the output from the sensing device 26, reflecting camera tilt past vertical, is sent to the scanning circuit 24 which inverts the scan, causing the image to “flip”. In other words, if the memory 22 was scanned from top to bottom before the camera reached a vertical position, the output of the sensing circuit would cause the scanning to occur from bottom to top, the effect being to invert or flip the image.

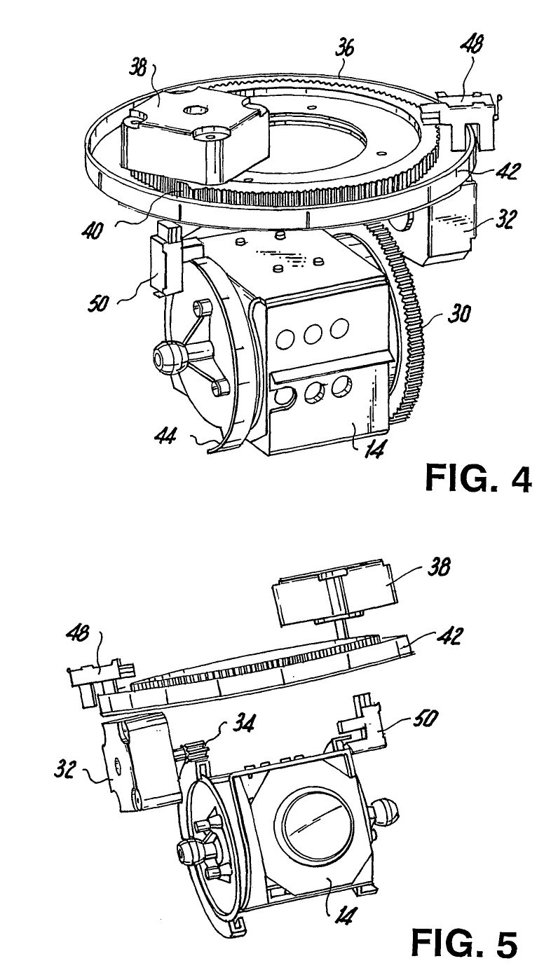

FIGS. 4 and 5 are perspective views showing a preferred mechanism for rotating the camera in pan and tilt. Except for the fact that 180° of tilt is provided, the mechanism is conventional and, therefore, not described in full detail. Camera 14 is connected to a tilt drive gear 30 so that the camera can be rotated about a horizontal (tilt) axis by means of a tilt drive motor 32. As shown in FIG. 5, the output shaft of motor 32 includes a spur gear 34 which engages the tilt drive gear 30.

Pan movement about a vertical (pan) axis is provided by a pan drive gear 36 which is driven by a motor 38 through a spur gear 40. As is well known in the surveillance art, operation of the pan and tilt drives can position camera 14 to cover the entire field beneath the camera. The camera, of course, would ordinarily be housed within a hemispherical dome.

It is necessary in a surveillance camera to know the exact direction in which the camera is pointed. For this purpose, a multi-slot pan encoder wheel 42 and a multi-slot tilt encoder wheel 44 are provided. Each of the encoder wheels 42 and 44 is stationary. The pan and tilt positions are read by a pan encoder 48 and a tilt encoder 50 which are attached to the respective gears 36 and 30 so that they move with the camera relative to the encoder wheels. Each of the encoders includes a single light emitting diode and sensor mounted on opposite sides of the encoder wheel to sense movement of a slot past the encoder.

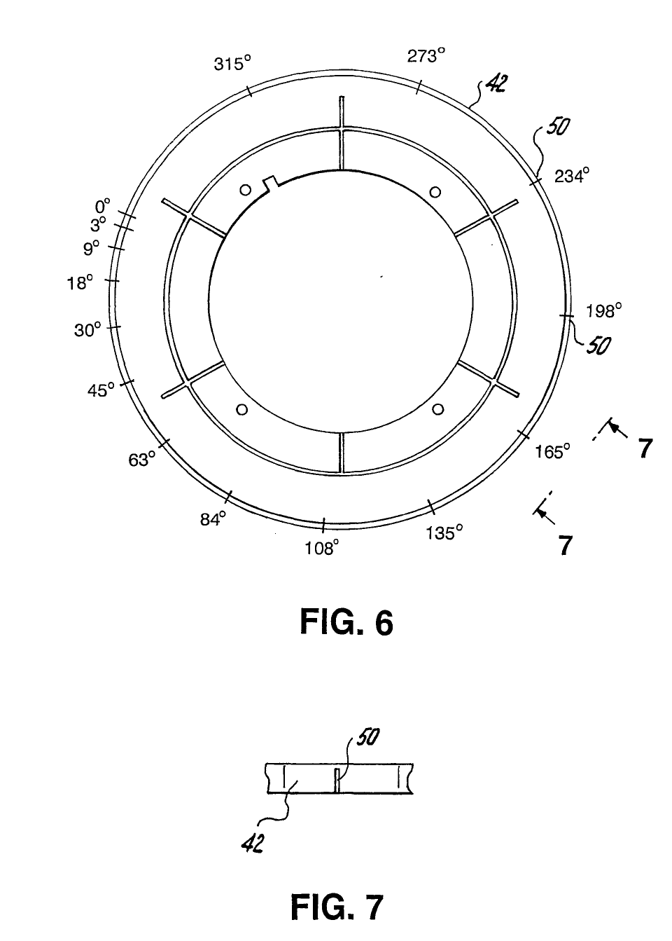

The arrangements of the slots on the pan encoder wheel and the tilt encoder wheel in a preferred embodiment of the invention are shown in FIGS. 6 and 7, respectively. Referring to FIG. 6, since the pan encoder wheel 42 must cover 360°, it includes a series of slots (fifteen in the example) with the spacing between adjacent slots differing around the circumference. In FIG. 6, the difference between adjacent slots increases by 3° in a counterclockwise direction from 0°. The motors 32 and 38 may be conventional stepper motors which are driven by pulses. By counting the number of pulses between adjacent slots the system can determine the direction in which the camera is pointed. For example, assuming for the sake of explanation that each pulse causes the motor to drive its associated gear by 1°, if nine pulses are counted between adjacent slots, the system would know that the camera had panned from 9° to 18°. If the number of pulses counted does not correlate to the spacing on the encoder wheel, then the system recognizes that an error has occurred. The electronic means for counting and keeping track of the camera position is known and, therefore, is not described herein in detail.

The tilt encoder 52 wheel is shown in FIG. 7. In the invention, the camera is capable of tilting more than 90°, for example, about 160° and the tilt encoder wheel covers an angular range from 0° to 157.8°. The tilt encoder wheel 44 includes ten slots 52 spaced as shown with the difference between adjacent slots increasing by 2.4°. The operation of the tilt encoder mechanism is the same as the pan encoder mechanism previously described.

The encoder wheels enable a rapid recalibration of the system in case the pulse count is lost. Since each interval between adjacent slots is different, the position of the motor can be checked and/or calibrated at each of the encoder slots so long as two slots pass the encoder. In the preferred embodiment, the camera position in sensed by counting the pulses used to drive the tilt motor. When the count reflects the vertical camera position, a “flip” signal is generated which inverts the scan to turn the image on the monitor right side up even though the camera is upside down.

There are many different systems used to scan a surveillance camera with respect to pan and tilt axis and the invention can be used with any drive mechanism. As one example, belt systems are commonly used. Likewise, the invention contemplates any encoding system which detects movement of the camera past vertical. Among other things, a simple switch or optical sensing system could easily be employed. Also, electronic image reversal techniques are well known and frequently used in the field of video signal processing. The invention contemplates the use of any device for sensing the camera position as well as any technique for reversing the image when the camera passes through vertical.

The camera 14 may be a commercially available camera which includes the image flip capability. A commercially available camera usable for this purpose is sold by Hitachi under model No. VK-S454. The Hitachi VK-S454 is a compact chassis type camera which is designed for surveillance under a wide range of light conditions and includes digital image flip capability.

What is claimed is:

1. A television system, comprising
a video camera rotatable with respect to a horizontal (tilt) axis;
means for sensing rotation of said video camera past a vertical position; and
electronic means for flipping the image produced by the camera in response to said
sensing means, whereby an upright image is produced when the camera scans past a vertical position without the need for rotating the camera about a vertical (pan) axis.

2. A television system according to claim 1, further including camera drive means for rotating said video camera about said horizontal (tilt) axis through an angle which includes a vertical position.

3. A television system according to claim 2, wherein said drive means includes pulse driven stepper motors, and wherein said electronic means for flipping the image includes means for counting the pulses coupled to said stepper motor, said electronic means for flipping the image being responsive to said counting means.
